(19) United States
(12) Patent Application Publication
(10) Pub. No.: US 2014/0067593 A1
(43) Pub. Date: Mar. 6, 2014

(54) CUSTOM DATA MERGE

(71) Applicants: Steven A. Schulman, Norwalk, CT (US); Peter Belbita, Milford, CT (US)

(72) Inventors: Steven A. Schulman, Norwalk, CT (US); Peter Belbita, Milford, CT (US)

(73) Assignee: MAFCOTE, INC., Norwalk, CT (US)

(21) Appl. No.: 14/066,388

(22) Filed: Oct. 29, 2013

Related U.S. Application Data
(63) Continuation-in-part of application No. 14/019,079, filed on Sep. 5, 2013.
(60) Provisional application No. 61/768,649, filed on Feb. 25, 2013.
(60) Provisional application No. 61/804,000, filed on Mar. 21, 2013.
(60) Provisional application No. 61/806,211, filed on Mar. 28, 2013.
(60) Provisional application No. 61/806,220, filed on Mar. 28, 2013.
(60) Provisional application No. 61/697,019, filed on Sep. 5, 2012.
(60) Provisional application No. 61/696,973, filed on Sep. 5, 2012.
(60) Provisional application No. 61/697,044, filed on Sep. 5, 2012.
(60) Provisional application No. 61/697,002, filed on Sep. 5, 2012.
(60) Provisional application No. 61/768,649, filed on Feb. 25, 2013.
(60) Provisional application No. 61/804,000, filed on Mar. 21, 2013.
(60) Provisional application No. 61/806,211, filed on Mar. 28, 2013.
(60) Provisional application No. 61/806,220, filed on Mar. 28, 2013.

(51) Int. Cl. G06Q 30/06

(52) U.S. Cl. CPC G06Q 30/0621
USPC 705/26.5

(57) ABSTRACT

One or more embodiments of techniques or systems for product design customization are provided herein. An interface for product design customization is provided with an application component that can run a stationery application, a merge application, an EZ print application, a photo paper application, etc. These applications may include the ability to insert, modify, or customize design elements. Additionally, these applications may enable a user to divide or split a product design into one or more product design portions, thereby layering the product design. Additionally, data may be merged across one or more documents associated with a product design. Product design reproduction, such as printing, may be limited or controlled according to one or more embodiments.

### CROSS-REFERENCE TO RELATED APPLICATIONS

This application claims the benefit of U.S. Provisional Patent Application Ser. No. 61/768,649 (Attorney Docket No. MFCT-2013-001P) entitled “SYSTEM AND METHOD OF CUSTOM DESIGN AND PRINTING”, filed on Feb. 25, 2013, U.S. Provisional Patent Application Ser. No. 61/804,000 (Attorney Docket No. MFCT-2013-003P) entitled “METHOD AND SYSTEM OF PRINTING”, filed on Mar. 21, 2013, U.S. Provisional Patent Application Ser. No. 61/806,211 (Attorney Docket No. MFCT-2013-004P) entitled “SYSTEM AND METHOD OF PRINTING”, filed on Mar. 28, 2013, and U.S. Provisional Patent Application Ser. No. 61/806,220 (Attorney Docket No. MFCT-2013-005P) entitled “SYSTEM AND METHOD OF DATA CONSOLIDATION”, filed on Mar. 28, 2013; additionally, this application is a continuation-in-part (CIP) of U.S. patent application Ser. No. 14/019,079 (Attorney Docket No. 108727.1US) entitled “INTERFACE FOR PRODUCT DESIGN CUSTOMIZATION”, filed on Sep. 5, 2013, which claims the benefit of expired U.S. Provisional Patent Application Ser. No. 61/697,019 (Attorney Docket No. MFCT-2012-003P) entitled “SYSTEM AND METHOD OF CUSTOM SIGNAGE”, filed on Sep. 5, 2012, expired U.S. Provisional Patent Application Ser. No. 61/696,973 (Attorney Docket No. MFCT-2012-001P) entitled “SYSTEM AND METHOD OF CUSTOM SIGNAGE”, filed on Sep. 5, 2012, expired U.S. Provisional Patent Application Ser. No. 61/697,044 (Attorney Docket No. MFCT-2012-004P) entitled “METHOD OF CUSTOM PRINTING”, filed on Sep. 5, 2012, expired U.S. Provisional Patent Application Ser. No. 61/697,002 (Attorney Docket No. MFCT-2012-002P) entitled “SYSTEM AND METHOD OF CUSTOM PRINTING”, filed on Sep. 5, 2012, U.S. Provisional Patent Application Ser. No. 61/768,649 (Attorney Docket No. MFCT-2013-001P) entitled “SYSTEM AND METHOD OF CUSTOM DESIGN AND PRINTING”, filed on Feb. 25, 2013, U.S. Provisional Patent Application Ser. No. 61/804,000 (Attorney Docket No. MFCT-2013-003P) entitled “METHOD AND SYSTEM OF PRINTING”, filed on Mar. 21, 2013, U.S. Provisional Patent Application Ser. No. 61/806,211 (Attorney Docket No. MFCT-2013-004P) entitled “SYSTEM AND METHOD OF PRINTING”, filed on Mar. 28, 2013, and U.S. Provisional Patent Application Ser. No. 61/806,220 (Attorney Docket No. MFCT-2013-005P) entitled “SYSTEM AND METHOD OF DATA CONSOLIDATION”, filed on Mar. 28, 2013. The entirety of the above-noted applications is incorporated by reference herein.

### BACKGROUND

Over the years, significant change has been seen with the means by which custom electronic document and printing is completed to create a custom electronic document associated with a product design. For many years, an individual designer worked with the customer for custom electronic document utilizing hand or electronic drawing methods and localized printing service, with delivery to the user after such printing service was completed. Currently, custom electronic document is often completed through the use of a custom electronic document service, copy center, hand created or using a pre-packaged software. The completion of custom electronic document within these platforms generally utilizes a workflow process, having interaction with the user in template population to complete the design. Many of these processes require the consumer to complete an in-person or online registration process. Generally, after the custom electronic document is completed, printing is completed at a designated printing device and the completed printed matter is picked-up or delivered to the customer through a mailing service.

However, the use of a custom printing device service or copy center may be costly to the user and have a time requirement of several days for production and delivery. The quality of the hand created sign depends on the ability of the creator and often is completed using the then-available pens and markers, often resulting in a final product that has errors and other variances associated with the hand-making process. Further, pre-packaged software can mitigate time delay to production and delivery and hand created look, but may present limitations with the templates and images associated with the software.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

One or more embodiments of techniques or systems for product design customization are provided herein. For example, an interface, point of entry or a portal is provided with a suite of applications that enable a user to customize one or more aspects of a product design. One or more of the applications can include a stationery application which facilitates customization of design elements, an EZ print application that further enables a user to layer a product design by dividing the product design into one or more portions or product design portions, a merge application that propagates source data to multiple fields across ‘copies’ of documents, and a photo paper application that can layer images, thereby enabling users to create mosaics of images, for example. In one or more embodiments, a user can create product designs through an interface and print portions of the product design to a printer.

A layering component is provided to segment, divide, or split an image or a product design into one or more portions or one or more product design portions, which when printed, can be assembled to form a large format product design. In this way, large format product designs are made possible, even when large format printers are unavailable.

Additionally, a merge component is provided to enable a user to propagate source data across one or more field of one or more similar documents, such as certificates. This means that a user can purchase a stack of certificates, for example, place the stack in their printer, upload a file with a list of names, and have their printer complete the certificates accordingly. Certificates may include printed paper or other medium for an award, achievement, diploma or certificate, a combination of text and images, text, one or more images, etc. In one or more embodiments, a user can utilize the UI component 110 to select a certificate template, populate the template with text and images across one or more fields, and print the template to a printer.

In one or more embodiments, reproduction of the product designs may be controlled or limited. For example, a user may be limited to a predetermined number of prints. As another example, the number of prints available to a user may be based on a pay per print model, where the user loads an account with money to gain access to prints. In one or more embodiments, payment may be effected via a portal, a product design customization interface, website, etc.

The following description and annexed drawings set forth certain illustrative aspects and implementations. These are indicative of but a few of the various ways in which one or more aspects are employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is an illustration of an example component diagram of a system for product design customization, according to one or more embodiments.

FIG. 2 is an illustration of an example flow diagram of a method for product design customization, according to one or more embodiments.

FIG. 3 is an illustration of an example flow diagram of a method for product design customization, according to one or more embodiments.

FIG. 4 is an illustration of an example flow diagram of a method for product design customization, according to one or more embodiments.

FIG. 5 is an illustration of example layering printouts, according to one or more embodiments.

FIG. 6 is an illustration of an example flow diagram of a method for product design customization, according to one or more embodiments.

FIG. 7 is an illustration of an example flow diagram of a method for product design customization, according to one or more embodiments.

FIG. 8 is an illustration of an example interface for product design customization, according to one or more embodiments.

FIG. 9 is an illustration of an example interface for product design customization, according to one or more embodiments.

FIG. 10 is an illustration of an example interface for product design customization, according to one or more embodiments.

FIG. 11 is an illustration of an example interface for product design customization, according to one or more embodiments.

FIG. 12 is an illustration of an example interface for product design customization, according to one or more embodiments.

FIG. 13 is an illustration of an example computer-readable medium or computer-readable device including processor-executable instructions configured to embody one or more of the provisions set forth herein, according to one or more embodiments.

FIG. 14 is an illustration of an example computing environment where one or more of the provisions set forth herein are implemented, according to one or more embodiments.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

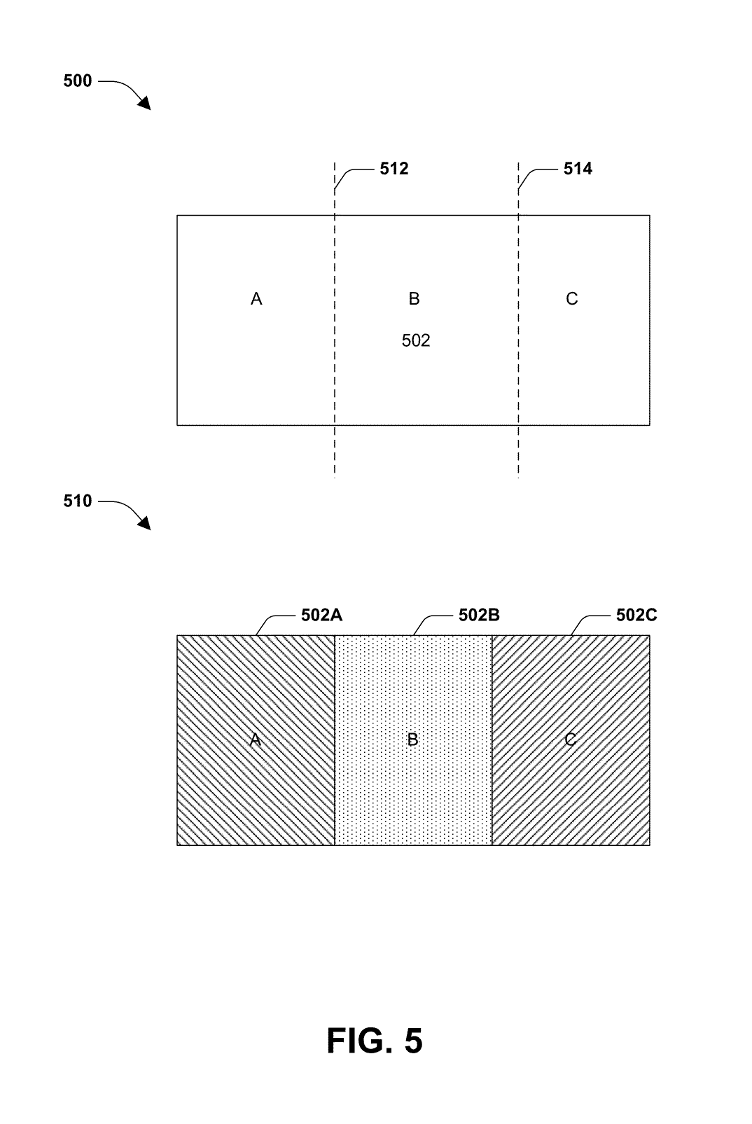

For one or more of the figures herein, one or more boundaries, such as boundary 502 of FIG. 5, for example, may be drawn with different heights, widths, perimeters, aspect ratios, shapes, etc. relative to one another merely for illustrative purposes, and are not necessarily drawn to scale. For example, because dashed or dotted lines may be used to represent different boundaries, if the dashed and dotted lines were drawn on top of one another they would not be distinguishable in the figures, and thus may be drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but can encompass a portion of one or more other components as well.

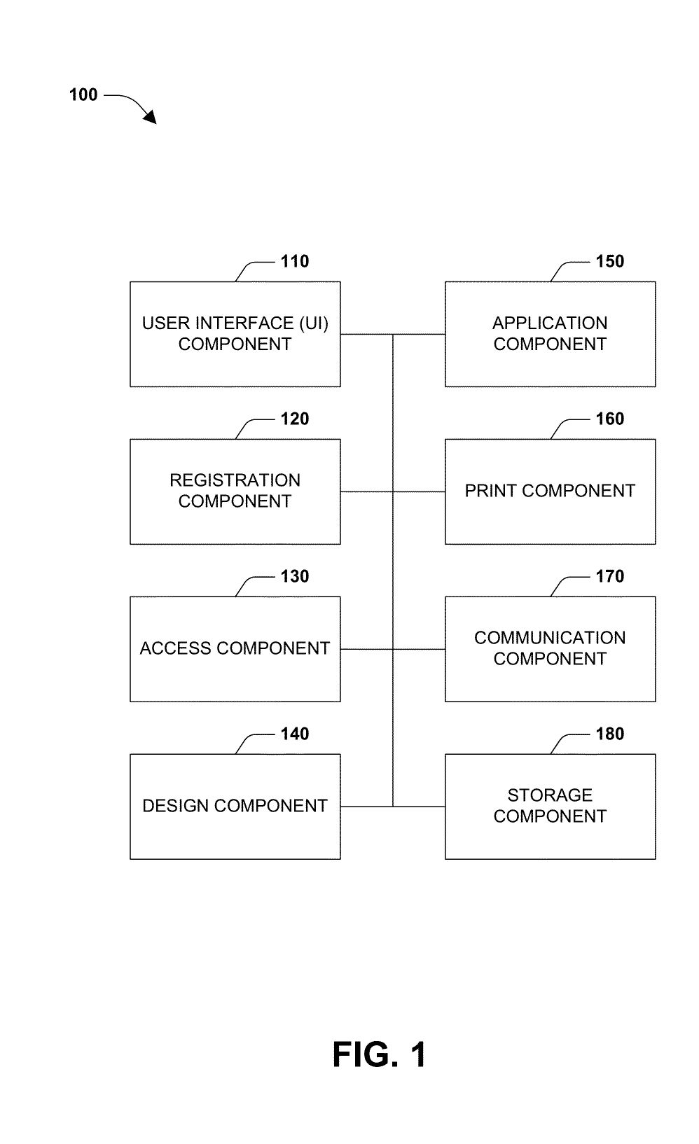

FIG. 1 is an illustration of an example component diagram of a system 100 for product design customization, according to one or more embodiments. The system 100 for product design customization of FIG. 1 can include a user interface component 110, a registration component 120, an access component 130, a design component 140, an application component 150, a print component 160, a communication component 170, or a storage component 180. After a user purchases a product, the user can utilize the system 100 as a point of entry or a portal to create, generate, customize, modify, etc. one or more product designs which correspond to the purchased product.

A product design can be a design that is created in a virtual environment, provided by the system 100, which when printed, can be assembled on a purchased product, and presented, for example. Designs may include advertisements, book reports, presentations, etc. As an example, the user may purchase a foam board which has a red background. When the user registers and logs into the system 100, he or she can select the foam board from a list of products and customize or create a product design for the foam board accordingly (e.g., with one or more design elements, etc.). That is, once the foam board is selected, the system 100 can present the user with a customization environment which effectively mirrors the foam board. In one or more embodiments, the background presented can have the same color as the purchased product (e.g., red in this example). Additionally, printouts of the product design or one or more portions of the product design (e.g., product design portions) may be scaled to fit or cover the purchased product when assembled, as will be discussed herein.

The UI component 110 of system 100 can effectively act as a point of entry, portal, or unified structure for a suite of applications. In other words, the UI component 110 can be a design center with a set of one or more tools or one or more applications that enable a user to customize product designs for products that the user has purchased. In one or more embodiments, the user may be able to access the design center via the UI component 110 by submitting payment information to the communication component 170, without necessarily purchasing a product. In other embodiments, the UI component 110 or one or more portions of the system 100 may only be accessible to a user upon purchasing a product and entering verification information, such as a verification code, product number, place of purchase, store purchased, date of purchase, etc.

The UI component 110 can host the point of entry, portal, or design center, which supports product lines, such as paper product lines or stationery lines. In other words, the point of entry, portal, design center, etc. can be a design program or interface accessible via the UI component 110 which enables users to create designs on personalized pre-printed stationery (e.g., using custom images, text, template, design elements, shapes, lines, etc.) or purchased stationery. The UI component 110 can include an application program interface (API) with libraries of routines, data structures, object classes, etc. associated with management, creation, or modification of design elements within a product design. In other embodiments, the point of entry, portal, or design center enables users to create designs on blank stationery in a similar fashion. Additionally, the UI component 110 may enable users to save a design to a storage component 180, create multiple pages, or create an album, for example.

Generally, paper products, purchased products, prospective purchases, etc. can include pre-perforated products, pre-marked products, boards (e.g., easel boards, foam boards, poster boards, project boards, sign boards, sign kits, etc.), brochures, cards, certificates, envelopes, invitations, letterhead, labels, mailing labels, parchment, photo paper, programs, seals, stationery kits, tags, tickets, signage, signs, banners, posters, engineering prints, adhesive paper, sticker paper, decals, images, vinyl signs, outdoor signs, etc. Paper products can be associated with a variety of attributes, such as paper size, or identifiers, such as an item number or product number. In other words, product generally includes packaging which can include an item number or product number, along with information associated with a point of entry or portal information. The product packaging can have information that enables a customer, consumer, client, user, etc. to navigate to a portal or website, and information that can be submitted to identify the user as a purchaser of the product.

The UI component 110 can host a portal or website which may be formed from one or more different applications, available or executed via the application component 150. That is, the UI component or portal can be a website which enables consumers or users to utilize one or more of the different applications. In one or more embodiments, the UI component 110 can host an EZ Print application, a stationery application, a merge application, and a photo paper application. In any event, this portal can be a unified structure which offers a suite of applications for users or customers, such as consumers who have purchased products or paper products from a vendor associated with the portal. The UI component 110 can be configured to display the product design, one or more of the product design portions, the image, one or more of the image portions, or one or more associated documents.

The UI component 110 or portal can host a suite of one or more applications at a single location. As a result, a consumer or user can have access to these applications or modules from one point of entry or a unified structure. For example, a consumer or user can purchase a product or paper product, register, and login to the portal to gain access to a variety of customization tools or design tools specific to the purchased product by utilizing one or more of the applications. Because the point of entry is a portal or a website, software may not necessarily be installed on a device the consumer or user is utilizing to access the portal or the UI component 110. In this way, a variety of customization tools can be consolidated within a portal or a unified structure hosted by the UI component 110.

In one or more embodiments, one or more sets of customization options, customization applications, or customization tools may exist within each application or each module. In other words, the portal or unified structure can include different sets of customization options or customization tools for different applications or customization options or tools which are common across multiple applications or modules. Stated yet another way, one or more of the applications can be structured to include one or more customization tools which may be common across one or more of the applications or unique to that application. For example, a consumer may be limited to an application based on the purchased product. In this way, customization tools of customization options within the portal can be utilized within merely some of the applications or all of the applications.

It will be appreciated that applications, components, modules, etc. may be implemented in together in groups, as a suite, or individually. For example, one or more applications may require payment before access is granted, while other applications may be free to use. In one or more embodiments, one or more portions of one or more applications or one or more portions of the system 100 may require payment while other portions of the same application or system 100 may not require payment for utilization.

The registration component 120 can be configured to receive registration information and link the registration information to an account. For example, registration information can include a place of purchase, date of purchase, item number, product number, universal product code (UPC), account information, username, email address, password, contact information, purchase history, etc. Additionally, the registration component 120 can be configured to associate an account with a product design or one or more product design portions, such as a product design that is saved or stored on the storage component 180. In one or more embodiments, the registration component 120 can be configured to register different accounts for different applications within the system 100 or UI component 110. For example, a user may be required to register a first account to utilize an EZ print application and a second account with a merge application, etc. In other embodiments, the user may merely register a single account to utilize one or more of the applications.

As used herein a product design can include one or more portions of the product design or one or more product design portions. Product design portions can be printed out on paper products or the like and assembled. Once assembled, the product design portions can effectively represent a large scale or large format version of the product design, which can be customized to fit a purchased product. For example, a standard paper size is 8½×11 inches. If a customer or user purchases a poster board that is 2×2 feet, four product design portions can be printed and assembled to form a ‘mosaic’ or large format version of the product design which would occupy 17×22 inches of the 24×24 inch poster board. Additionally, a user, as used herein, can be a customer, prospective customer, consumer, individual, entity, client, etc.

The access component 130 can be configured to receive registration information or account information and grant access or deny access to one or more portions of the system 100, an associated account, or a product design accordingly. In one or more embodiments, the access component 130 can be configured to match an item number or product number with a place of purchase or store of purchase and grant or deny access to one or more portions of the system 100 accordingly. That is, the user can enter or input a product number and a place of purchase. Here, the access component 130 can match these inputs based on a database of product numbers and retailers and grant or deny user access accordingly.

In one or more embodiments, the access component 130 can be configured to grant or deny a user access to an account, a product design, one or more product design portions, one or more applications, the system 100, one or more portions of the system 100, etc. The access component 130 can be configured to make a determination for the access based on a product number, item number, user input, date of purchase, type of product, type of application, product design, a balance associated with an account, etc. For example, the access component 130 can grant access to an account if a user has a credit balance on the account (e.g., money in the account). As another example, the access component 130 may be configured to grant, limit, or control access to applications based on a product number. For example, if a customer or user purchases a large format product, the access component 130 may be configured to merely grant the user access to applications applicable to large format products. That is, if a user enters a product number or item number associated with a large format foam board, the access component 130 may deny that user access to the photo paper application (e.g., because the user did not purchase photo paper). If the user later enters or inputs a product number associated with photo paper, the access component 130 may grant the user access to the photo paper application at that time, for example.

The design component 140 can be a component that enables a user to setup a product design for a purchased product. It will be appreciated that although one or more embodiments are described with reference to a purchased product, this can include prospective purchases in one or more embodiments. For example, in one or more embodiments, a user may access the system 100 to design a product design for a product that is not yet purchased. That is, in these embodiments, the user may be permitted to design or customize a product design without necessarily purchasing the product. However, one or more aspects of the system 100 may be disabled for users who have not purchased the product or entered authorized registration information (e.g., product number, item number, place of purchase, etc.). For example, saving of product designs may be disabled or printing or product designs may be disabled. The print component 160 may be configured to disable printing of such product designs or place watermarks on product designs or product design portions to be printed, etc. Similarly, the storage component 180 may be disabled in one or more of these scenarios. However, the communication component 170 can be configured to receive payment information to enable one or more aspects or functionality associated therewith.

In one or more embodiments, the design component 140 can include one or more design tools or design applications that enable a user to customize a product design for a purchased product. That is, the design component 140 can be configured to insert, remove, modify, or customize one or more design elements into the product design. Additionally, the design component 140 can be configured to receive one or more attributes associated with a purchased product, incorporate one or more of the attributes into the product design or product design portions. In this way, the user may be presented with a design environment which emulates or mirrors the physical design of the purchased product. For example, if a user purchases a green poster board which is 3×3 feet and enters or inputs the corresponding product number or item number at registration or login to the portal or UI component 110, the design component 140 may be configured to automatically pull up or create a product design for a 3×3 foot poster board with a green background.

In other embodiments, the design component 140 may be configured to receive one or more attributes associated with the purchased product or product information. For example, product information can include a purchased product selection, a purchased product size, an item number, a UPC, a product number, etc. In this way, the design component 140 can be configured to load an appropriate or corresponding background color for a product design. In other examples, the design component 140 can load other pre-printed images as a portion of the product design (e.g., which is not printed). If a user enters product information associated with a certificate or selects a certificate from a menu of certificates, the design component 140 can include the background of the certificate as a non-printed portion of the product design. In any event, attributes such as pre-printed background or sizing information may be included as a portion of the product design, such as when a product is selected by the user or upon entering product information or an item number, for example.

Additionally, the design component 140 can be configured to receive additional information, such as a paper size for large format printing, a desired orientation or orientation selection, etc. In this way, the design component 140 can facilitate creation of mosaics or the like by dividing, splitting, or slicing a product design into one or more product design portions, as will be discussed herein with reference to the layering application or the layering component (not shown). In one or more embodiments, the design component can be configured to receive a product design portion size which can be a selection of a paper size associated with printing of one or more product design portions. That is, for example, a product design for a large format foam board may be printed on 8½×11 inch paper and assembled on the large format foam board, wherein the 8½×11 inch paper size is the product design portion size. Additionally, the orientation selection can be chosen such that one or more of the product design portions are printed portrait or landscape.

In one or more embodiments, the design component 140 can be configured to generate the product design based on one or more of the attributes associated with the purchased product, product information, purchased product selection (e.g., corresponding to a purchased product), a purchased product size, an item number, a UPC, a product number, etc. This means that the design component 140 can be configured to incorporate these attributes or aspects into the design environment provided by the system 100 or the UI component 110 of FIG. 1. Accordingly, the design component 140 can enable the product design to mirror the purchased product or prospective purchase, etc.

The design component 140 can include design tools that enable a user to customize a product design in a variety of ways. For example, the design component 140 can insert design elements into the product design. Design elements or design objects can include attributes, text, font, color, shapes, lines, borders, interiors of shapes, pictures, custom images, clip art, logos, etc. The design component 140 can provide or enable a user to customize, modify, insert, remove, adjust positioning, adjust sizing, rotate, change, or otherwise manipulate one or more of the design elements.

In one or more embodiments, the design component 140 can provide one or more templates for one or more product designs. Templates can include pre-made product designs with one or more design elements. Templates may be professionally developed and may include text design elements, image design elements, and have a layout. In one or more embodiments, the design component 140 can suggest one or more layouts, one or more formats, or other content. In one or more embodiments, the design component 140 can enable a user to create a product design from scratch or a blank design.

The design component 140 can be configured to have tools that enable manipulation of design elements. For example, a color palette may be provided to enable users to select one or more colors for one or more of the design elements or one or more portions of the design elements. In one or more embodiments, clip art or one or more of the shapes can include one or more portions which may be manipulated by the design component 140. For example, shapes provided by the design component 140 may include a border and an interior area. Users can utilize the design component 140 to re-size or reposition a shape as a whole. Additionally, the design component 140 can enable the user to change the color of the border of a shape and the interior area of the shape independently, thereby enabling customization of product designs. In one or more embodiments, font attributes (e.g., bold, italics, underline, type, size, etc.) can be modified, added, applied, or removed, etc.

The design component 140 can be configured to enable a hover over preview feature that allows a user to visualize a change without necessarily implementing or saving the change. For example, when the user selects a design element, such as text, the design component 140 can present a preview of changes in font attributes, such as text size, italics, bold, underline, change in font, etc. Additionally, the design component 140 can enable a user to create an album, copy, paste, cut, duplicate, select, modify, etc. one or more design elements.

The design component 140 or UI component 110 can be configured to allow a user to select a signage template, including the dimensions, shape, and size of final signage for printing and pre-defined document design layout of text and image location, as applicable. Additionally, the UI component 110 can be configured for template population, using available images, graphics, and text for placement within the template. The signage template shall be capable of receiving free text, as may be defined and placed within the template by the user. Text font shall be additionally defined within the template by the user. Image data may include stock images as available on the interface or images as uploaded by the user into the interface, for user specific use. In one or more embodiments, the UI component may enable the user to utilize digital image manipulation effects, as available between the interface and the user, for the placement and manipulation of images, graphics, and text within the template.

The UI component 110 can present a user with an option to save a product design, such as after the user has customized the product design. In one or more embodiments, the storage component 180 can be configured to save or store the product design. For example, the product design may be stored server side or locally on a device utilized by the user to access the UI component 110. In one or more embodiments, a product design may be saved as a template for future use and stored on the storage component 180.

The application component 150 can be configured to execute one or more applications. One or more of the applications can include customization tools that enable the user to modify design elements for a product design. In one or more embodiments, the application component 150 can be configured to execute an EZ print application, a stationery application, a merge application, a photo paper application, etc. One or more applications can be associated with different registration information or different accounts. For example, applications can be implemented individually or as a suite within the system 100, the UI component 110, portal, point of entry, etc. In other words, each application can be associated with different logins, accounts, or registration information.

The stationery application can be utilized to design product designs for standard format paper products. As an example, after a user purchases a corresponding paper product, accesses the UI component 110, registers, logs in, selects the purchased product, the stationery application can utilize the design component 140 to customize the product design, such as by utilizing templates, inserting design elements, modifying design elements, etc.

In one or more embodiments, the application component 150 or the design component 140 can include a layering component (not shown) or a merge component (not shown). The layering component can be configured to divide a product design into one or more product design portions based on a purchased product size (e.g., size of the purchased product), the product design portion size (e.g., the size of printer paper available to a user), and the orientation selection, wherein the product design portions have the product design portion size. In other words, the layering component can enable piece by piece printing for large format products, thereby enabling a user to create custom signage at home, for example. The layering component can split or divide one or more portions of a product design or an image into one or more product design portions, that when assembled, effectively re-create the product design as a large format product, as will be discussed with reference to FIG. 5. In one or more embodiments, the layering component can be configured to divide the product design into one or more of the product design portions based on a tiling algorithm.

As an example, the tiling algorithm may determine a height ‘H1’ and a width ‘W1’ for the purchased product and a height ‘h2’ and a width ‘w2’ for a product design portion (e.g., paper size available to the user). A mosaic or stitching of one or more of the product design portions can be determined such that there are n×m product design portions, wherein n=ceiling (W1/w2) and m=ceiling (H1/h2). In this way, the layering component can generate one or more of the product design portions based on a paper size, desired product design size, product design size, or purchased product size. In one or more embodiments, the layering component can adjust one or more of the product design portions based on bordered or borderless printing or an orientation selection. In one or more embodiments, the purchased product can be a large format product, easel board, foam board, poster board, project board, sign board, sign kit, etc. In an alternate embodiment, a populated product design, as a large image, may be printed or apportioned among multiple sheets of product and assembled as a signage product. This enables the populate template image to be printed in standard page-sized pieces and assembled as a larger final signage product. In one or more embodiments, the apportioned printing could be completed as borderless printing. The custom signage, product design, or customized product design, once printed, may be mounted or otherwise adhered to a display medium, such as an exterior vinyl sign, banner, for outdoor use, on poster board, foam board, etc.

The EZ print application can utilize the layering component and the design component 140 or customization tools thereof to facilitate design and printing of large format products or large format printing. Similarly, the EZ print application can utilize customization tools associated with the design component 140 to customize one or more design elements of a product design. The EZ print application can divide the product design into one or more product design portions utilizing the layering component, wherein a product design portion is associated with a product design portion size, such as a size of printer paper associated with a printer available to the user. For example, most users at home have 8½×11 paper or A4 among the available options.

Similarly, a photo paper application can include design tools, stationery tools, layering tools, etc. Additionally, the photo paper application may enable users to scale images to different sizes. For example, the photo paper application can enable users to scale images smaller than standard size or to a large format. This enables users to create mosaics out of images printed on photo paper. In this way, the photo paper application can be utilized to ‘stitch’ virtually any size product design to form an image or product design. The photo paper application may utilize the layering component, the design component 140, or tools thereof to achieve layering or customization. The photo paper application can receive an image, divide the image into one or more image portions, wherein the product design includes the image. The photo paper application may be configured to enable printing or customization across a variety of photo paper sizes, such as 12×12, 4×6, 5×7, 8×10, passport sizing, etc.

In one or more embodiments, the merge application utilizes a merge component to achieve merging of data across one or more documents or one or more certificates. Generally, a product design associated with a certificate can include a non-printable certificate background which can be previewed within the UI component 110 and one or more fields. A certificate can have text which indicates that an individual has completed an achievement, etc. One or more of the fields can include a name field, a date field, a certification details field, data, etc. The merge application can enable a user to merge data across certificates, pre-printed certificates, mailing labels, labels, letterhead, envelopes, and the like.

The merge component allows a user to select a purchased product or a product from a list or a menu, for example. The merge component can be configured to receive a source data file. The source data file can include data to be propagated across one or more of the fields. In other words, the source data file can include one or more source data entries. The source data file may be a list, a text file, a spreadsheet, a comma separated value file, etc. In one or more embodiments, the application component 150 can be configured to receive the source data file and transmit the source data file to the merge component.

The merge component can be configured to identify one or more fields within a product design, such as a product design for a certificate. In this way, one or more fields may be identified. The merge component can be configured to generate one or more documents with one or more fields or corresponding fields. As an example, one or more of these documents may have a substantially similar or identical product design. The merge application may utilize the design component 140 to customize one or more fields within the product design. What this means is that the design component can be configured to enable users or consumers to create custom product designs by placing fields where desired. These fields can have sizes, positions, or other attributes defined by a user. In other words, the design component can receive one or more user inputs, wherein one or more of the user inputs can define a location and a size for one or more fields. In one or more embodiments, a field can be a design element. This enables a user to customize the product design with one or more fields based on one or more of the user inputs.

The merge component can receive a source data file including one or more source data entries. Additionally, the merge component can generate one or more documents having the customized product design. The merge component can be configured to propagate one or more source data entries to one or more fields across one or more documents associated with the product design. This propagation can be based on the customized product design. In this way, the merge component and the design component can enable users to create a custom product design with one or more fields or custom fields and propagate data across one or more documents having a same product design.

In one or more embodiments, the propagating can be based on a property of one or more of the source data entries. What this means is that properties of text from a source data entry can be inherited or transferred such that one or more of the properties are preserved when the merge component propagates the source data or source data entries across one or more of the documents. For example, if a source data file has a list of names in bold or in a specific font (e.g. Arial font), the merge component can propagate the list of names such that one or more of the names appears in a name field and in the same font as the source file (e.g., Arial in this example) or bold. In this way, one or more properties or one or more attributes (e.g., text font, text size, text attribute, etc.) can be preserved or inherited during the merge process or propagation. It will be appreciated that source data can be propagated or merged across multiple documents, multiple pages, or to a select number of pages or documents.

As an example, a user who has purchased a pack of certificates can navigate to the UI component 110 or point of entry for the system 100, register, login, etc. Upon inputting a purchased product which corresponds to the certificates purchased, the UI component 110 can load a product design which corresponds to the purchased product or certificate. The merge component may enable a user to customize one or more design elements within the product design via the design component 140, as discussed herein. Additionally, the product design or design elements can include one or more fields, such as a name field and a date field. In one or more embodiments, the merge component can be configured to receive a source data file.

In other embodiments, one or more of the fields can be customized to define or lock characteristics or attributes such that properties or attributes are not preserved or inherited during the merge process or propagation. For example, if a field is defined with a font or text font of Times New Roman, a source data entry that is in Arial will be converted to Times New Roman upon propagation by the merge component.

In one or more embodiments, the merge component can propagate one or more fields in an automatic fashion without input from a source data file or source data entries based on a type of field or a property of a field. For example, a date field can automatically be propagated with a date, a day field can automatically be propagated with a day, a time field can automatically be propagated with a time, etc.

For example, the source data file can include a list of names, such as Adam, Betty, and Charlie. Here, the merge component can identify the name field within the product design as a field which source data entries are to be propagated. The merge component may generate one or more documents having a substantially similar or identical product design, such as three documents having a certificate design mirroring the design of the pre-printed certificate purchased. The merge component can then propagate one or more of the source data entries to one or more of these fields. In this example, a first document can inherit Adam in the name field, the second document can inherit Betty in the name field, and the third document can inherit Charlie in the name field. When the print component 160 prints these documents, it will be appreciated that the background for the certificates is generally not printed, because the background is already on the pre-printed certificate. In this way, a printable portion of the product design may include the fields or other additional design elements while a non-printable portion of the product design may include the background, etc.

In one or more embodiments, a user can select one or more merge-able templates and customize one or more corresponding product designs. After customization, the user can select a merge option by clicking on a merge button within the UI component 110. This may generate a popup window to save a selected template prior to merging. The template may be saved as an XML file within the storage component 180. Further the template may be associated with a unique template ID or one or more other variables. After the XML file is loaded, XML content may be rendered by parsing text nodes of text elements of one or more of the design elements within the template. Attributes may be preserved and applied during propagation. A source data file may be received and parsed. Rendered or merged documents may be displayed by the UI component 110 thereafter.

In one or more embodiments, the application component 150 can execute a gridline application or a guideline application which can facilitate printing of cards on non-perforated products or non-marked products, such as blank stationery, for example. That is, if a user purchases paper stock or paper product that is blank or blank stationery, the gridline application can be utilized to design a product design that prints one or more gridlines or guidelines to be cut or folded by the user, thereby forming a desired product, such as a business card from a business card design, etc. For example, business cards may include professional and personal introduction cards, a combination of text and images, text, or one or more images. When printed, the custom business cards can include printed guide lines on the printed medium for the user to follow when cutting out the individual cards having a size of a traditional business card. In one or more embodiments, the custom business cards can include printed guide lines on the printed medium in the then-designated standard or custom dimensions, shape, and size for the user to follow when cutting out the individual cards.

As with other applications, the gridline application can utilize design tools or customization tools provided by the design component 140, thereby enabling the user to customize design elements, including the background, etc., or a product design created by the gridline application. In one or more embodiments, the gridline application can enable users to print backgrounds. When the print component 160 prints these documents or product designs, the background is generally printed, because the user has blank stationery or paper stock, for example. Accordingly, the printable portion of the product design may include the background. To this end, a user, customer, client, consumer, etc. can utilize the gridlines or guidelines to score, cut, fold, etc. their own product. Further, the gridline application may enable the user to create custom sizing by moving gridlines, for example. In one or more embodiments, the gridlines or guidelines may be lighter in color, dashed, dotted, etc.

A design component 140 of a system for creating purchased product designs separated by guidelines can be configured to receive a purchased product selection. This purchased product selection can correspond to a non-perforated product, such as paper stock, etc. The design component can be configured to generate a product design based on the purchased product selection. That is, if a user or consumer purchases paper stock intended for use as business cards, the selection of such paper stock may automatically bring up a product design for a business card, one or more templates for business cards, etc. The purchased product can have a purchased product size, which may be A4 or 8½×11 inches, etc. The product design can have a smaller size, such as the size of a business card or standard business card, for example. In other words, the product design can be associated with the purchased product and have a product design size smaller than the purchased product size so that multiple product designs (e.g., business cards) may be printed on a single sheet of paper stock.

An application component 150 can be configured to propagate one or more portions of the product design onto a purchased product design. Additionally, the application component can insert one or more guidelines within the purchased product design to distinguish between one or more propagated product designs within the purchased product design. The UI component 110 can display one or more of the guidelines, the product design, one or more propagated product designs, or the purchased product design. The application component 150 can propagate one or more portions of the product design onto the purchased product design such that one or more of the portions are substantially identical or different. What this means is that the application component 150 can generate identical business cards or product designs that are identical or business cards or product designs which are similar, or have a similar layout, but are unique from one another, for example.

In one or more embodiments, the access component 130 may enable access to the gridline application or guideline application based on receiving payment information from the communication component 170. The payment information may be linked to an account associated with the user via the registration component 120. To this end, the communication component 170 may be configured to receive payment information and load a balance associated with an account with funds, for example. The payment information can be associated with a product design, an account, an account balance, one or more product design portions, a number of available prints, etc.

In one or more embodiments, the communication component 170 can be configured to provide a user with a live chat capability. In other words, the communication component 170 can provide a user with a live chat interface that enables the user to communicate with a customer service representative (CSR). The CSR can interact with the user and identify product information, account information associated with the user. Additionally, the user can interact or inquire about questions pertaining to one or more portions of the system 100 or one or more of the applications (e.g., EZ print application, merge application, photo paper application, etc.).

The print component 160 can be configured to generate a print preview for the product design for a purchased product (e.g., or associated product design portions). The print component 160 can be configured to print the product design one or more of the product design portions, the image, one or more of the image portions, or one or more documents. In one or more embodiments, the print component 160 can utilize a borderless printing feature of a printer associated with a device on which the user is utilizing to access the system 100. This means that the print component 160 can print one or more product design portions in a borderless or bordered fashion. For example, the print component 160 can be configured to receive one or more printing preferences, such as borderless printing, bordered printing, paper size, paper orientation, etc. In one or more embodiments, the print component can detect a type of printer associated with a user device (e.g., borderless or bordered).

The print component 160 can be configured to print to a file, print to a printer, etc. The print component 160 may be configured to enable or disable printing of a product design or one or more product design portions to a file based on an account balance, for example. In other words, the user's ability to print may be based on payment, which may be received by the communication component 170.

In one or more embodiments, the print component 160 can be utilized to limit reproduction of a product design or product design portions. The print component 160 can be configured to install a print application on a user device (e.g., the device the user is utilizing to access the system 100). This print application can be configured to enable or disable printing of the product design from the device or user device based on a balance associated with an account or an account balance. For example, the print application can monitor or control a number of prints associated with a product design or product design portions. As a result of this, a user can only print a predetermined number of prints or a number of prints which have been paid. In one or more embodiments, payment may be effected via the communication component 170. The print component 160 can be configured to transmit a print application to the user device. The print application can monitor and limit or control the number of prints a user can print from the user device. The print application may be installed upon entry to the portal via the UI component 110, for example. This functionality can exist or ‘live’ within the system 100. In this way, limited reproduction of prints can be provided.

In one or more embodiments, the number of prints available may be based on a product number. For example, if the user purchases 25 sheets of paper stock, when the corresponding product number is entered at registration with the registration component 120, the number of prints may be set to 25. That is, the print component 160 may be configured to interface with the registration component 120 to determine the number of prints available to a user. Here, the print component 160 can receive an item number or a product number from the registration component 120. As an example, if a user enters an item number associated with 25 sheets of paper, the user may be limited to 25 prints. In one or more other embodiments, the print component may limit prints to an arbitrary number of prints, such as 40 prints or 40 prints per print job, etc.

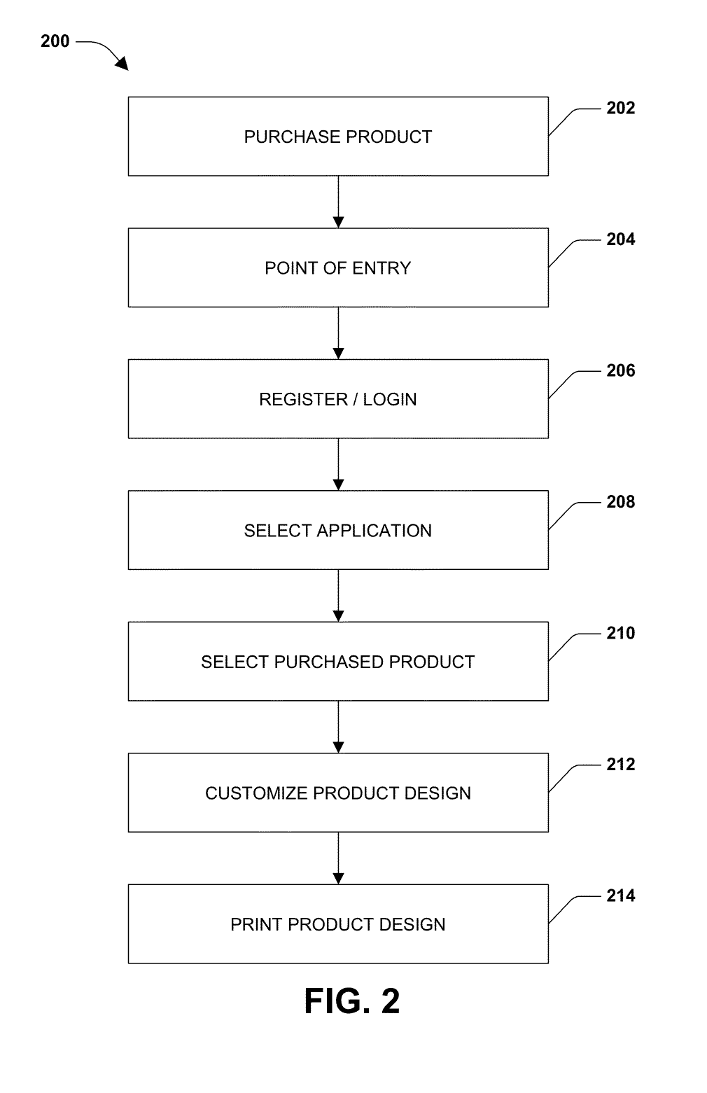

FIG. 2 is an illustration of an example flow diagram of a method 200 for product design customization, according to one or more embodiments. Generally, a user, customer, consumer, client, etc. purchases a product at 202, and navigates to the point of entry at 204. Point of entry information can be provided on packaging associated with the product. Additionally, registration or login information may be provided on the packaging as well. At 206, the user can register, create an account, or login to the point of entry. At 208, the use can select an application to customize their product with and further select a purchased product at 210. At 212, the user can customize their product by creating a product design. At 214, the user can print the product design. In one or more embodiments, payment information may be required before the product design or product design portions can be printed.

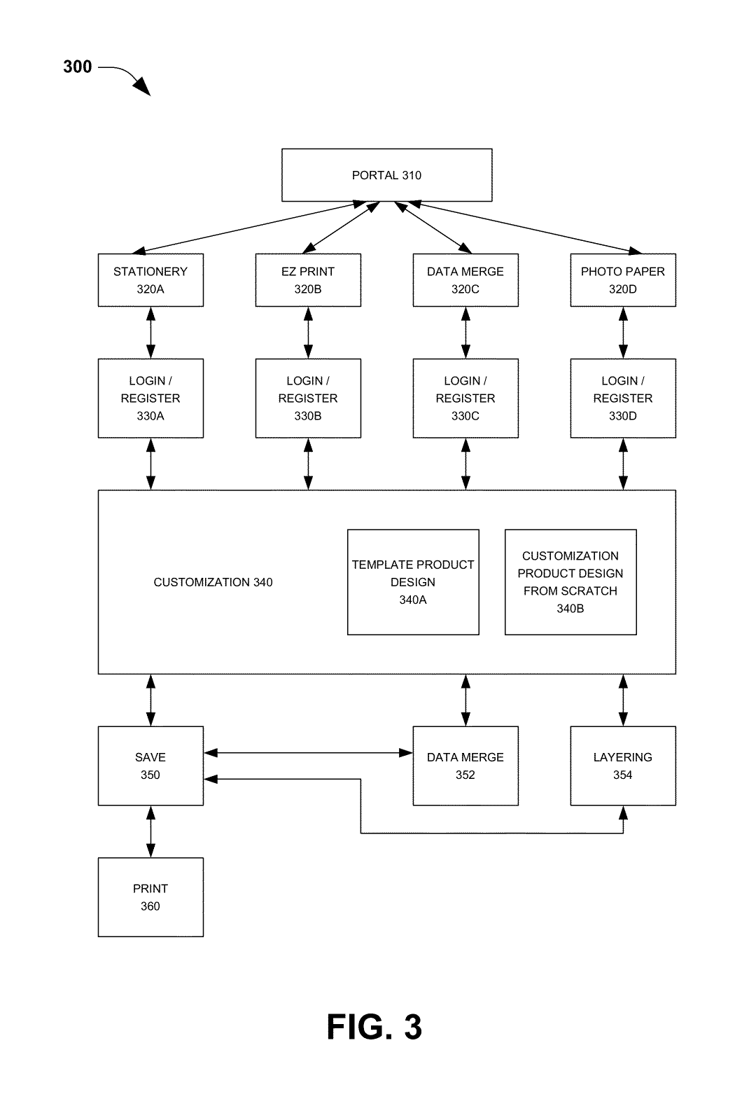

FIG. 3 is an illustration of an example flow diagram of a method 300 for product design customization, according to one or more embodiments. At 310, a user can enter a portal, unified structure, or interface, such as an IClickNPrint website, for example. At 320A, 320B, 320C, or 320D, the user can select one or more applications for product design customization. For example, the stationery application 320A can be utilized to add, edit, modify, remove, etc. design elements for a product design. The EZ print and photo paper applications 320B and 320D, respectively, can be utilized for large format products or large format printing by layering a product design or image, effectively dividing the product design or image into one or more portions, which when assembled, form the large format product design. It will be appreciated that a standard printer may be utilized, to print one or more of the product design portions.

At 330A, 330B, 330C, and 330D, a user can login or register with one or more of the respective applications or modules. Additionally, customization may be available at 340. For example, templates are available at 340A while customization from scratch 340B may also be an option. At 352, data can be merged if utilizing the merge application 320C. Similarly, layering may be available for one or more of the applications, such as EZ print 320B or photo paper 320D. The product design can be saved at 350 and printed at 360.

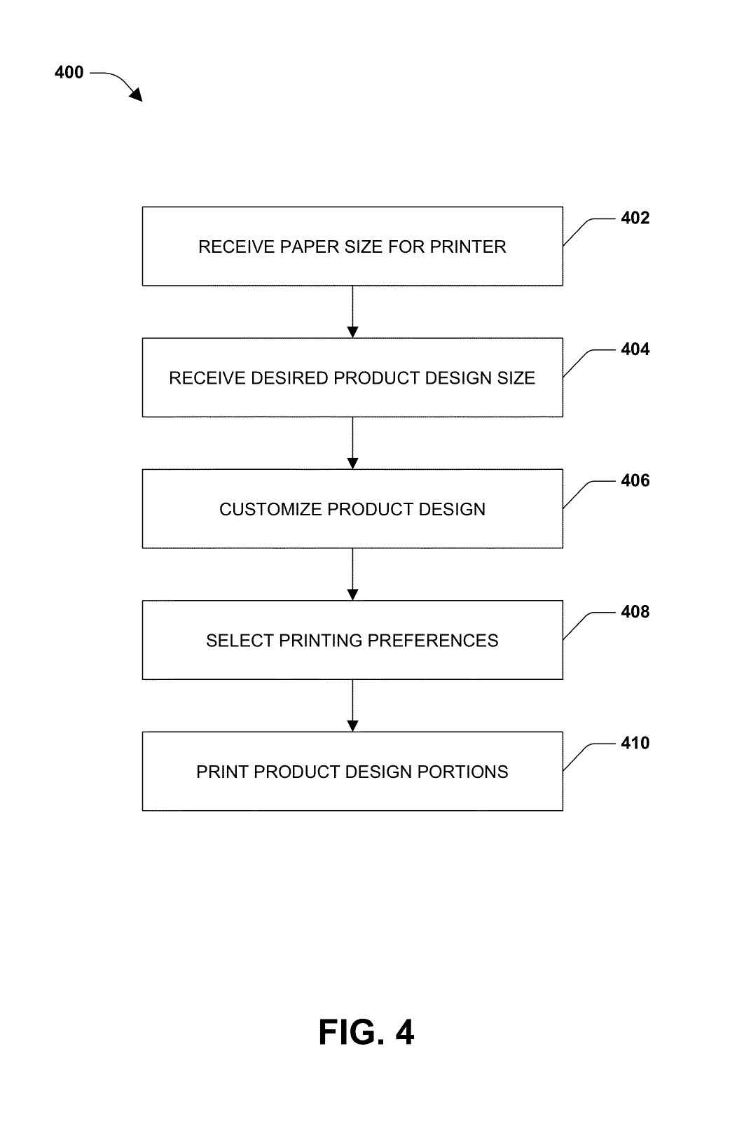

FIG. 4 is an illustration of an example flow diagram of a method 400 for product design customization which may include layering, according to one or more embodiments. At 402, a paper size is received, wherein the paper size is associated with a printer available to the user or connected to the user device. At 404, a desired product design size can be received. For example, this may be a size of a purchased product or a purchased product size. At 406, the product design can be customized. At 408 printing preferences may be received, inputted, or selected, such as by a user. At 410, one or more of the product design portions can be printed.

FIG. 5 is an illustration of example layering printouts 500 and 510, according to one or more embodiments. At 502, a product design is seen. The product design 502 can include a first portion A, a second portion B, and a third portion C. As presented by the UI component 110 of FIG. 1, the product design may appear as a single continuous design. Alternatively, the UI component 110 may indicate page breaks 512 and 514, based on a selected paper size, for example. At 510, one or more product design portions 502A, 502B, and 502C can be seen. These product design portions can be printed on individual sheets of paper, paper product, paper stock, or other product, etc. These sheets may be a standard size, such as A4 or 8½×11 inches, for example. However, when assembled, 502A, 502B, and 502C, can form a large format product design. In one or more embodiments, the layering component of FIG. 1 can be configured to provide one or more alignment marks to facilitate assembly.

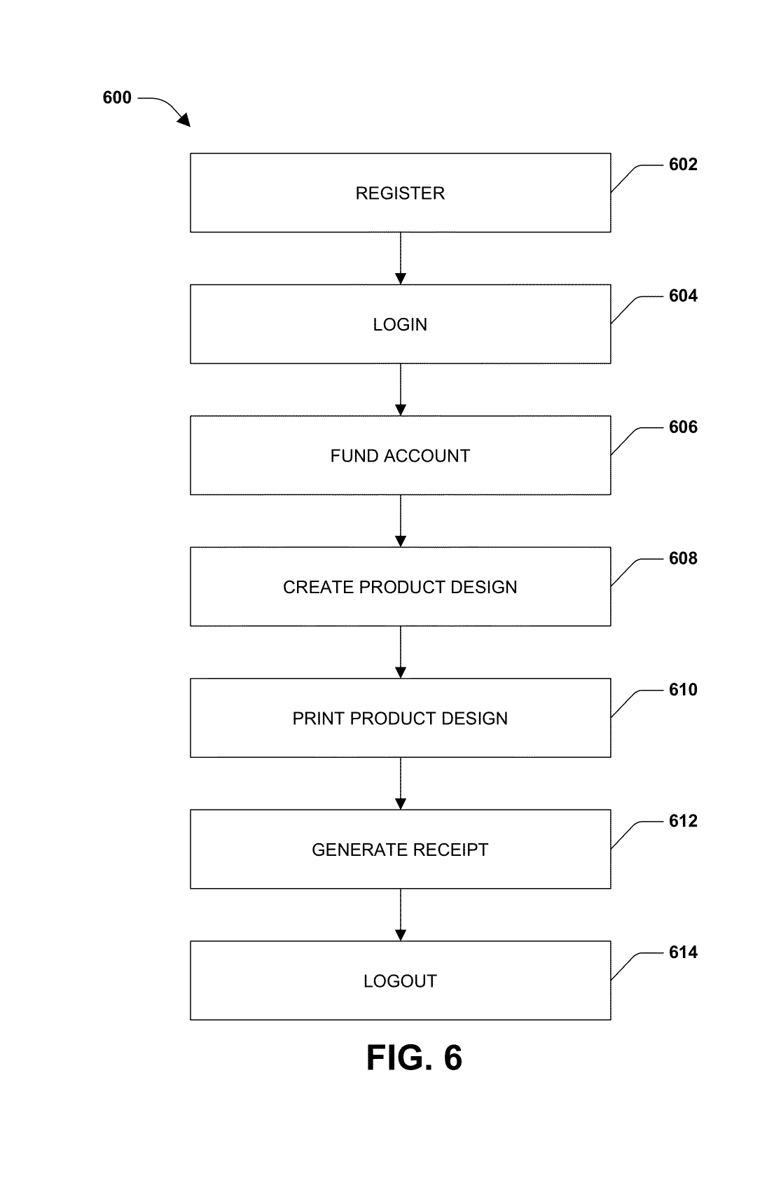

FIG. 6 is an illustration of an example flow diagram of a method 600 for product design customization, according to one or more embodiments. At 602, a user can register to enter a portal or point of entry. At 604, the user can login to the portal. At 606, the user may fund an account associated with the portal. At 608, the user may select a product and create a product design for that product. At 610, the user may print one or more portions of the product design. At 612, a receipt may be generated for the user and a debit applied to the account balance according to the quantity printed at 610. The receipt can be presented to the user by a UI component or emailed to the user, for example. At 614, the user can logout. In one or more embodiments, a counter may be utilized to count a number of copies available for printing. For example, a total number of copies may be compared against requested number of copies. If the requested number of copies is greater than the total number of copies available, printing may be disabled by the print component. Additionally, if a print is successful, an account balance may be updated thereafter to reflect the latest print job.

In one or more embodiments, total number of pages in a print job, a total number of print copies, application name, and print type are received. For example, total number of pages=total number of pages in project*total number of print copies. A total price can be calculated, and an account balance amount may be fetched using database query. Additionally the required amount can be calculated (e.g. available balance or insufficient funds). The UI component can display a current account balance, a print cost, required amount, etc. If there is a sufficient balance and the user clicks print, the print application can be launched. In one or more embodiments, the print application can provide a print preview of the product design.

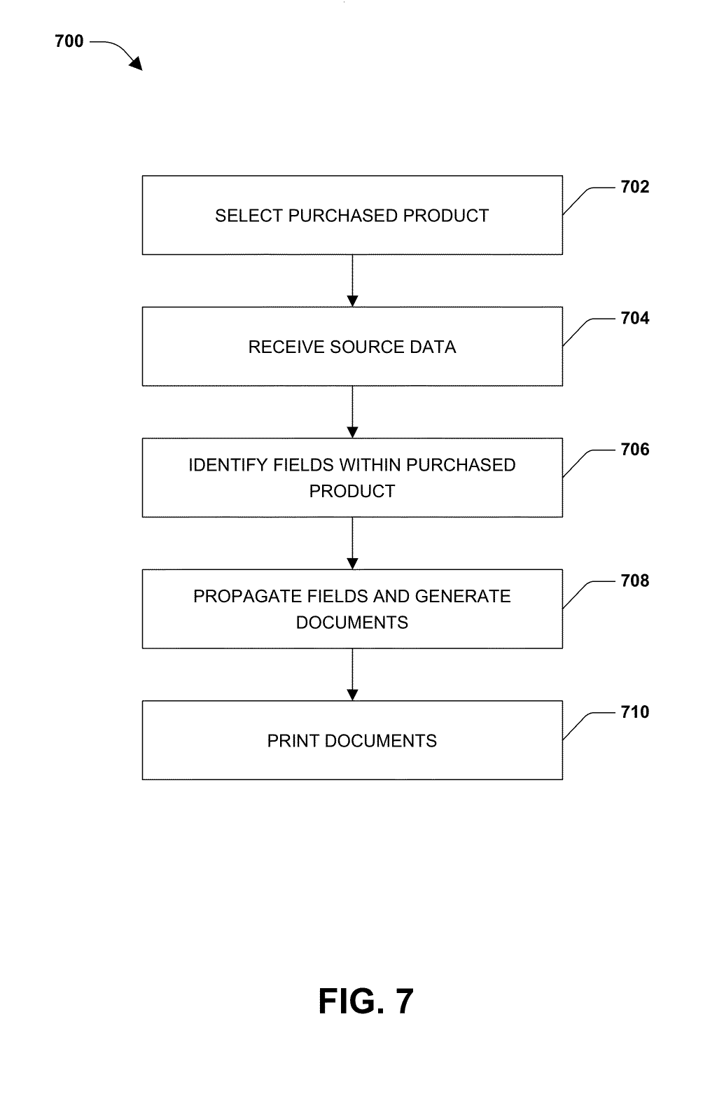

FIG. 7 is an illustration of an example flow diagram of a method 700 for product design customization, according to one or more embodiments. At 702, the user can select or input a purchased product, such as a set of certificates. At 704, source data, source data entries, or a source data file can be received. At 706, one or more fields can be identified. At 708, one or more of the fields can be propagated with one or more of the source data entries and one or more documents having similar product designs generated. At 710, one or more of the documents can be printed.

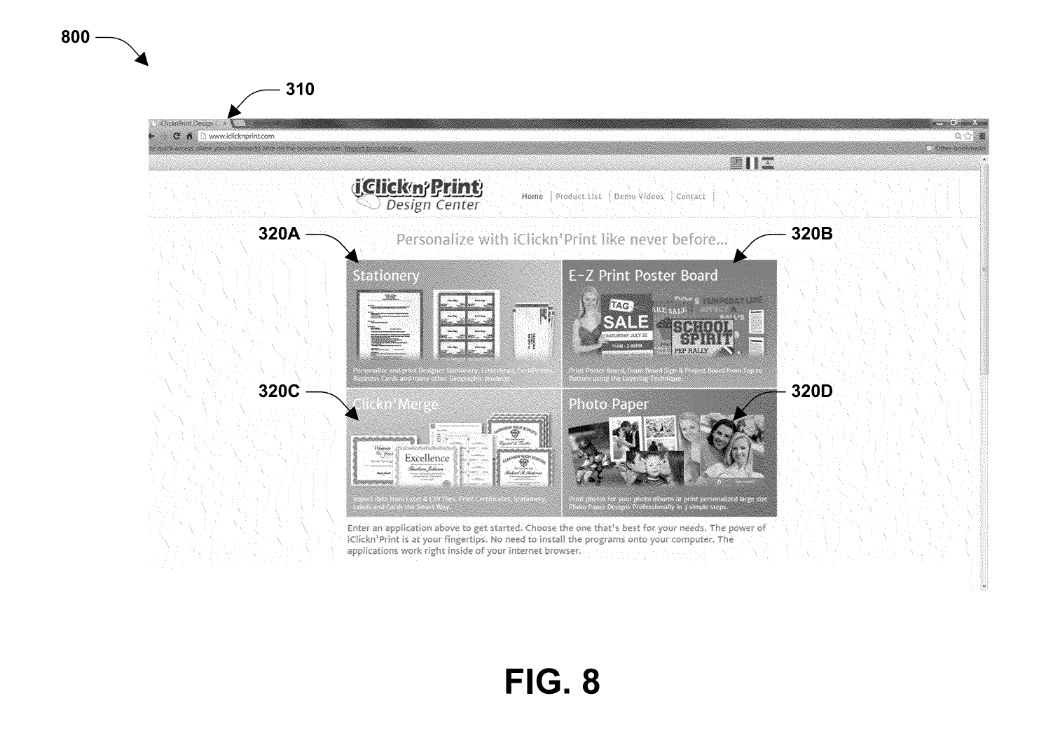

FIG. 8 is an illustration of an example interface 800 for product design customization, according to one or more embodiments. At 310, a portal or unified structure is seen. At 320A, 320B, 320C, and 320D, one or more applications can be launched within the user interface (UI) 800 of FIG. 8. In one or more embodiments, a user can be asked to register or login after selecting one or more of the applications of FIG. 8. Users may be asked to provide contact information or product information, including a product number and place of purchase.

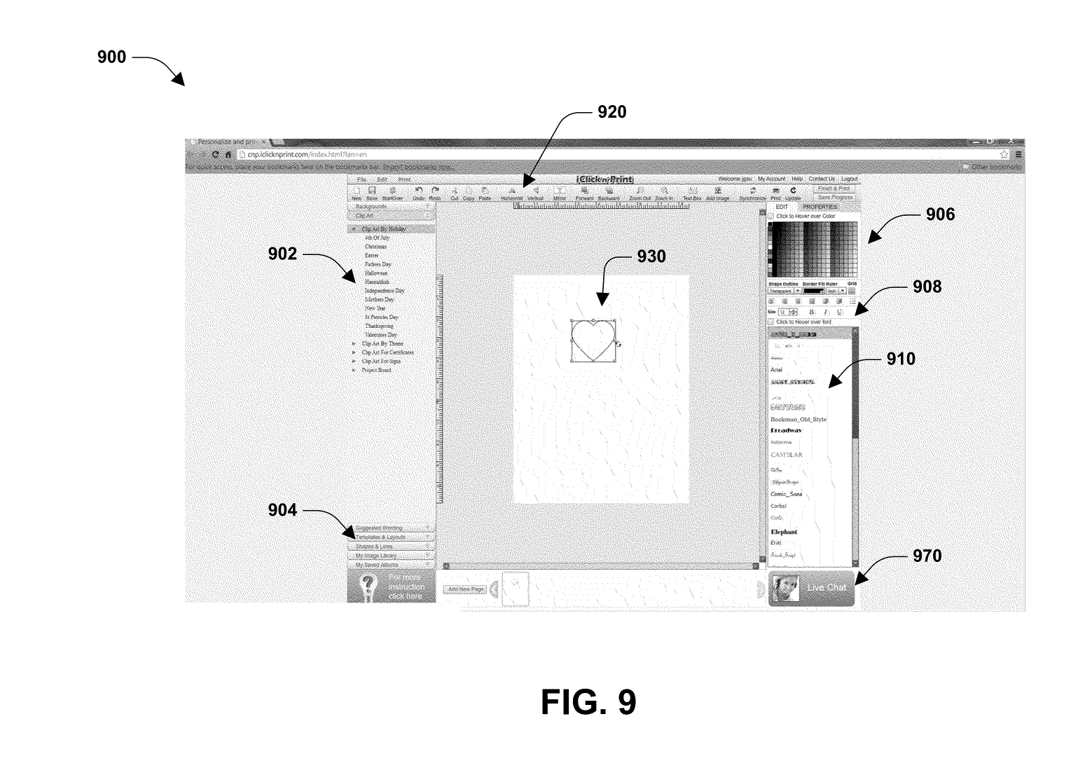

FIG. 9 is an illustration of an example interface 900 for product design customization, according to one or more embodiments. Interface 900 illustrates an example embodiment of a stationery application, including a product selection menu 902, customization tools 920, one or more templates 904, an editing area, one or more design elements at 930, a color palette 906, text properties 908, fonts 910, and live chat 970.

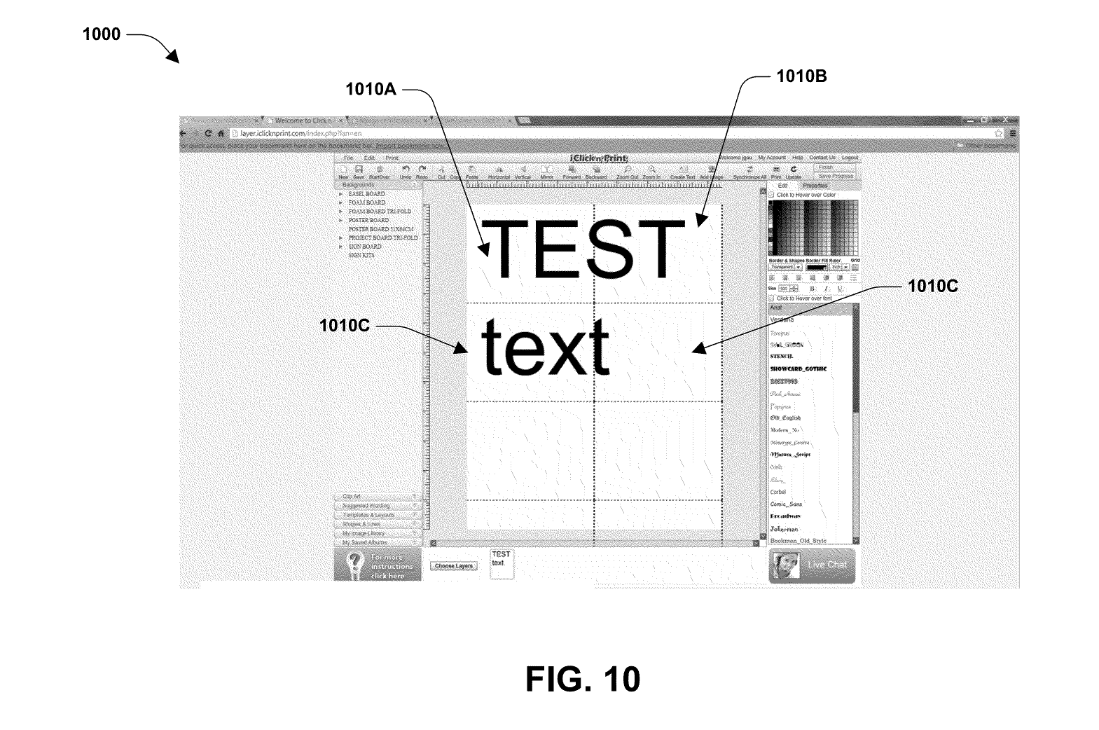

FIG. 10 is an illustration of an example interface 1000 for product design customization, according to one or more embodiments. FIG. 10 illustrates an example interface 1000 for an EZ print application. Here, the EZ print application shows page breaks which indicate that 1010A, 1010B, 1010C, and 1010D will be printed as shown, across four different pages.

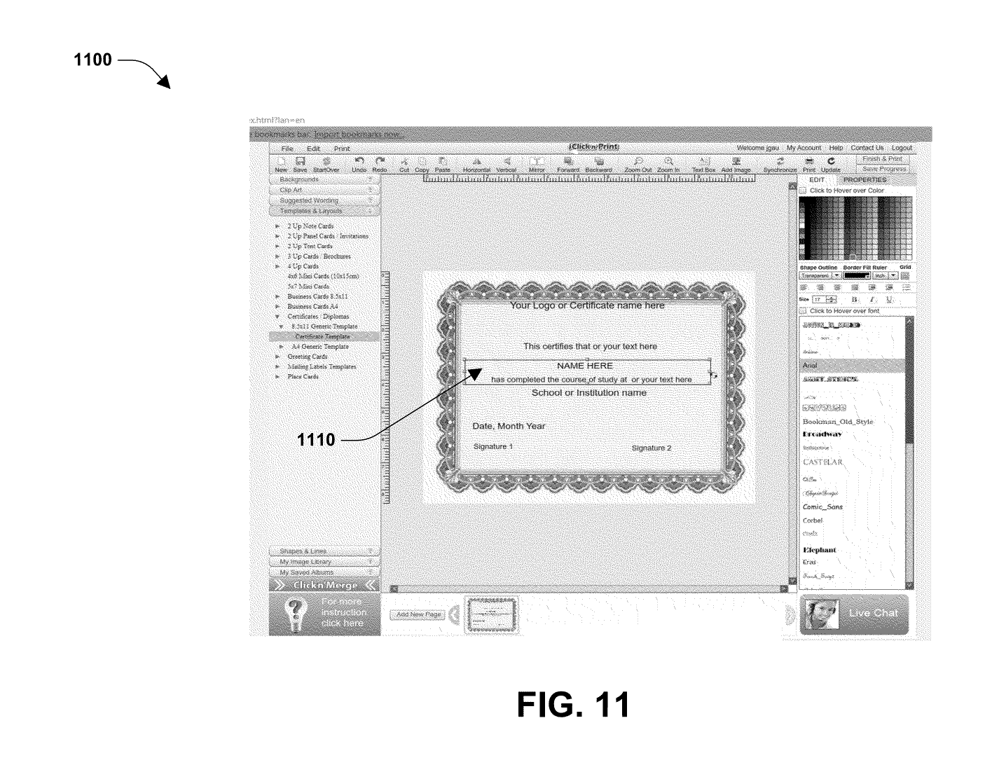

FIG. 11 is an illustration of an example interface 1100 for product design customization, according to one or more embodiments. At 1110, a name field is illustrated which can propagate one or more source data entries across one or more certificates.

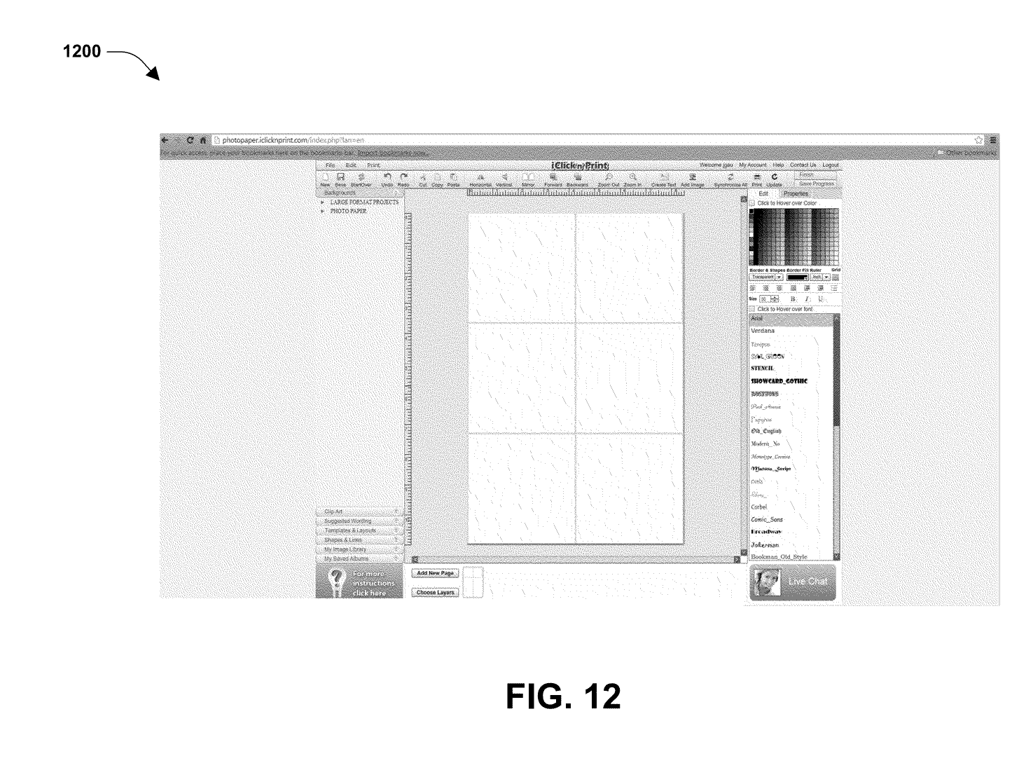

FIG. 12 is an illustration of an example interface 1200 for product design customization, according to one or more embodiments.

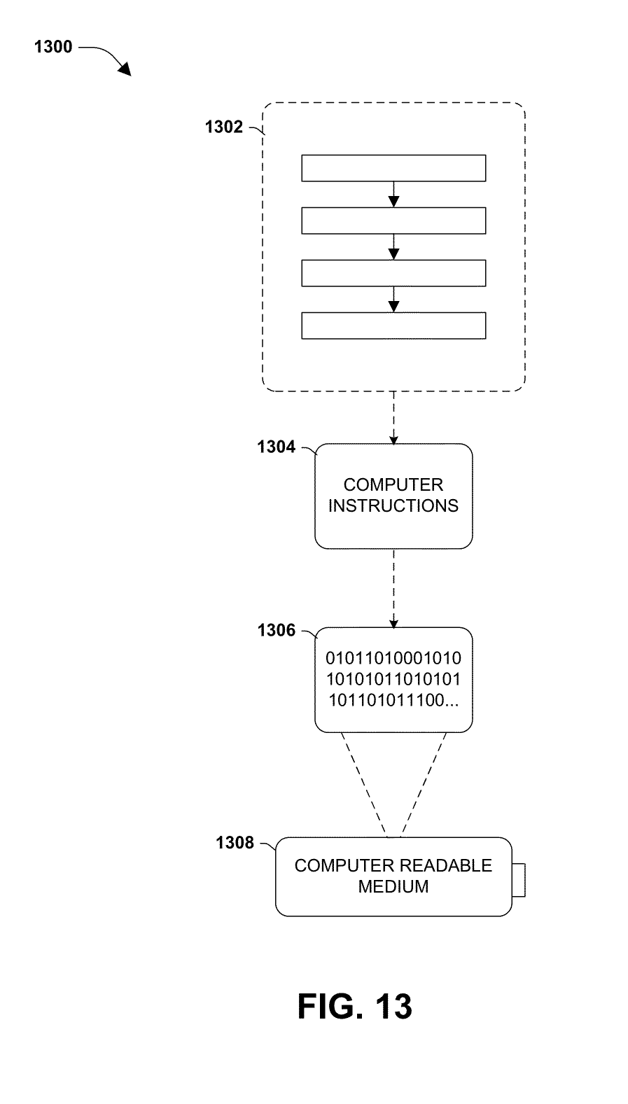

Still another embodiment involves a computer-readable medium including processor-executable instructions configured to implement one or more embodiments of the techniques presented herein. An embodiment of a computer-readable medium or a computer-readable device that is devised in these ways is illustrated in FIG. 13, wherein an implementation 1300 includes a computer-readable medium 1308, such as a CD-R, DVD-R, flash drive, a platter of a hard disk drive, etc., on which is encoded computer-readable data 1306. This computer-readable data 1306, such as binary data including a plurality of zero's and one's as shown in 1306, in turn includes a set of computer instructions 1304 configured to operate according to one or more of the principles set forth herein. In one such embodiment 1300, the processor-executable computer instructions 1304 are configured to perform a method 1302, such as the method 300 of FIG. 3 or the method 400 of FIG. 4. In another embodiment, the processor-executable instructions 1304 are configured to implement a system, such as the system 100 of FIG. 1. Many such computer-readable media are devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

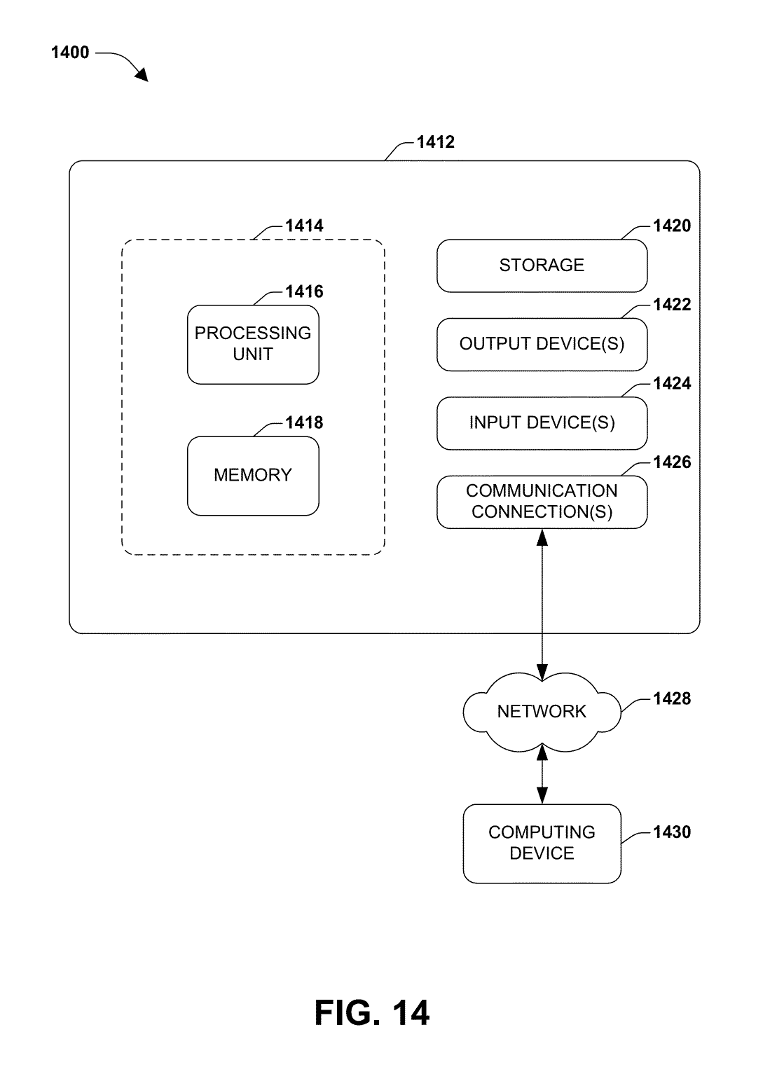

FIG. 14 and the following discussion provide a description of a suitable computing environment to implement embodiments of one or more of the provisions set forth herein. The operating environment of FIG. 14 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions can be distributed via computer readable media as will be discussed below. Computer readable instructions can be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 14 illustrates a system 1400 including a computing device 1412 configured to implement one or more embodiments provided herein. In one configuration, computing device 1412 includes at least one processing unit 1416 and memory 1418. Depending on the exact configuration and type of computing device, memory 1418 may be volatile, such as RAM, non-volatile, such as ROM, flash memory, etc., or a combination of the two. This configuration is illustrated in FIG. 14 by dashed line 1414.

In other embodiments, device 1412 includes additional features or functionality. For example, device 1412 can include additional storage such as removable storage or non-removable storage, including, but not limited to, magnetic storage, optical storage, etc. Such additional storage is illustrated in FIG. 14 by storage 1420. In one or more embodiments, computer readable instructions to implement one or more embodiments provided herein are in storage 1420. Storage 1420 can store other computer readable instructions to implement an operating system, an application program, etc. Computer readable instructions can be loaded in memory 1418 for execution by processing unit 1416, for example.

The term “computer readable media” as used herein includes computer storage media. Computer storage media includes volatile and nonvolatile, removable and non-removable media implemented in any method or technology for storage of information such as computer readable instructions or other data. Memory 1418 and storage 1420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1412. Any such computer storage media is part of device 1412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 1412 includes input device(s) 1424 such as keyboard, mouse, pen, voice input device, touch input device, infrared cameras, video input devices, or any other input device. Output device(s) 1422 such as one or more displays, speakers, printers, or any other output device may be included with device 1412. Input device(s) 1424 and output device(s) 1422 can be connected to device 1412 via a wired connection, wireless connection, or any combination thereof. In one or more embodiments, an input device or an output device from another computing device can be used as input device(s) 1424 or output device(s) 1422 for computing device 1412. Device 1412 can include communication connection(s) 1426 to facilitate communications with one or more other devices.

According to one or more aspects, a system for product design customization is provided, including a design component configured to receive a purchased product selection, generate a product design based on the purchased product selection, wherein the purchased product selection corresponds to a purchased product, wherein the product design is associated with the purchased product, and insert or modify one or more design elements into the product design. The system can include an application component configured to execute an EZ print application, a stationery application, a merge application, and a photo paper application. The EZ print application can divide the product design into one or more product design portions, wherein a product design portion of one or more of the product design portions is associated with a product design portion size. The stationery application can customize one or more of the design elements or the product design. The merge application can propagate one or more source data entries to one or more fields across one or more documents associated with the product design. The photo paper application can receive an image and divide the image into one or more image portions, wherein the product design includes the image. The system can include a user interface (UI) component configured to display the product design, one or more of the product design portions, the image, or one or more of the image portions.

The system can include a registration component configured to associate an account with the product design, an access component configured to grant access or deny access to the account or the product design based on a product number associated with the purchased product, a print component configured to print the product design, one or more of the product design portions, the image, or one or more of the image portions. The system can include a communication component configured to provide live chat with a customer service representative (CSR). The communication component can be configured to receive payment information. The system can include a storage component configured to store the product design. In one or more embodiments, the application component can be configured to receive a source data file including one or more of the source data entries. The UI component can be configured to display the product design, one or more of the product design portions, the image, or one or more of the image portions based on a cursor position on a palette.

According to one or more aspects, a method for product design customization is provided, including receiving a purchased product selection and generating a product design based on the purchased product selection. The purchased product selection can correspond to a purchased product and the product design may be associated with the purchased product. The method can include providing one or more applications. One or more of the applications can be for inserting or modifying one or more design elements into the product design, dividing the product design into one or more product design portions, wherein a product design portion of one or more of the product design portions is associated with a product design portion size, customizing one or more of the design elements or the product design, propagating one or more source data entries to one or more fields across one or more documents associated with the product design, or dividing an image into one or more image portions, wherein the product design includes the image. The method can include displaying the product design, one or more of the product design portions, the image, or one or more of the image portions.

In one or more embodiments, the method includes associating an account with the product design, granting access or denying access to the account or the product design based on a product number associated with the purchased product, printing the product design, one or more of the product design portions, the image, or one or more of the image portions, providing live chat with a customer service representative (CSR), or storing the product design.

According to one or more aspects, computer-readable storage medium including computer-executable instructions, which when executed via a processing unit on a computer performs acts, including receiving a purchased product selection and generating a product design based on the purchased product selection, wherein the purchased product selection corresponds to a purchased product, wherein the product design is associated with the purchased product. Additionally, one or more of these acts can include providing one or more applications and displaying the product design, one or more of the product design portions, the image, or one or more of the image portions. One or more of the applications can be for inserting or modifying one or more design elements into the product design, dividing the product design into one or more product design portions, wherein a product design portion of one or more of the product design portions is associated with a product design portion size, customizing one or more of the design elements or the product design, propagating one or more source data entries to one or more fields across one or more documents associated with the product design, or dividing an image into one or more image portions, wherein the product design includes the image.

According to one or more aspects, a system for layering a product design includes a design component configured to receive a purchased product selection, a purchased product size, a product design portion size, and an orientation selection, generate a product design based on the purchased product selection, wherein the purchased product selection corresponds to a purchased product, wherein the product design is associated with the purchased product, and insert or modify one or more design elements into the product design. The system can include a layering component configured to divide the product design into one or more product design portions based on the purchase product size, the product design portion size, and the orientation selection, wherein the product design portions have the product design portion size. The system can include a user interface (UI) component configured to display one or more of the product design portions.

In one or more embodiments, the purchased product is a large format product. In other embodiments, the purchased product is a standard format product. The layering component can be configured to divide the product design into one or more of the product design portions based on a tiling algorithm. The purchased product may be an easel board, foam board, poster board, project board, sign board, or sign kit. The UI component can include an application program interface (API). The system can include an access component configured to grant access or deny access to the product design based on a product number associated with a large format product. The system can include a print component configured to print one or more of the product design portions. The system can include a storage component configured to store the product design. One or more of the product design portions can be printed as a borderless product design portion.

According to one or more aspects, a method for layering a product design is provided including receiving a purchased product selection, a purchased product size, a product design portion size, and an orientation selection, generating a product design based on the purchased product selection, wherein the purchased product selection corresponds to a purchased product, wherein the product design is associated with the purchased product, inserting or modifying one or more design elements into the product design, dividing the product design into one or more product design portions based on the purchase product size, the product design portion size, and the orientation selection, wherein the product design portions have the product design portion size, and displaying one or more of the product design portions.

The method can include dividing the product design based on a tiling algorithm or utilizing an application program interface (API) to present one or more of the product design portions. The purchased product may be an easel board, foam board, poster board, project board, sign board, or sign kit. The method can include granting access or denying access to the product design based on a product number associated with a large format product or printing one or more of the product design portions.

According to one or more aspects, a computer-readable storage medium including computer-executable instructions, which when executed via a processing unit on a computer performs acts, including receiving a purchased product selection, a purchased product size, a product design portion size, and an orientation selection, generating a product design based on the purchased product selection, wherein the purchased product selection corresponds to a purchased product, wherein the product design is associated with the purchased product, inserting or modifying one or more design elements into the product design, dividing the product design into one or more product design portions based on the purchase product size, the product design portion size, and the orientation selection, wherein the product design portions have the product design portion size, and displaying one or more of the product design portions.

In one or more embodiments, the dividing of the product design can be based on a tiling algorithm. The purchased product can be an easel board, foam board, poster board, project board, sign board, or sign kit. One or more of the acts can include granting access or denying access to the product design based on a product number associated with a large format product.

According to one or more aspects, a system for merging data across one or more certificates is provided, including a design component configured to receive a purchased product selection and generate a product design based on the purchased product selection, wherein the purchased product selection corresponds to a purchased product, wherein the product design is associated with the purchased product. The system can include a merge component configured to receive a source data file including one or more source data entries, identify one or more fields within the product design, generate one or more documents having the product design, and propagate one or more of the source data entries to one or more of the fields across one or more of the documents. The system can include a user interface (UI) component configured to display one or more of the documents, wherein the respective documents have respective source data entries in the respective fields. This can mean that one or more of the fields within a document are displayed, one or more design elements are displayed, or a pre-printed background for the purchased product is displayed.

In one or more embodiments, the purchased product is a pre-printed certificate. The merge component can be configured to customize one or more of the fields within the product design. One or more of the fields can be a name field, a date field, or a certification field. The source data file can be a text file or a spreadsheet. The system can include a print component configured to print one or more of the fields. The print component can be configured to print one or more of the documents to a file. In one or more embodiments, the propagating can be based on a property of one or more of the source data entries. The system can include an access component configured to grant access or deny access to the merge component based on a product number associated with a pre-printed certificate product. Additionally, the product design may be implemented in extensible markup language (XML).

According to one or more embodiments, a method for merging data across one or more certificates is provided, including receiving a purchased product selection and a source data file including one or more source data entries, generating a product design based on the purchased product selection, wherein the purchased product selection corresponds to a purchased product, wherein the product design is associated with the purchased product, identifying one or more fields within the product design, generating one or more documents having the product design, propagating one or more of the source data entries to one or more of the fields across one or more of the documents, or displaying one or more of the documents, wherein the respective documents have respective source data entries in the respective fields.

In one or more embodiments, the purchased product can a pre-printed certificate, one or more of the fields can be a name field, a date field, or a certification field, the source data file can be a text file or a spreadsheet, the propagating can be based on a property of one or more of the source data entries, or the product design can be implemented in extensible markup language (XML).

According to one or more embodiments, a computer-readable storage medium including computer-executable instructions, which when executed via a processing unit on a computer performs acts, including receiving a purchased product selection and a source data file including one or more source data entries, generating a product design based on the purchased product selection, wherein the purchased product selection corresponds to a purchased product, wherein the product design is associated with the purchased product, identifying one or more fields within the product design, generating one or more documents having the product design, propagating one or more of the source data entries to one or more of the fields across one or more of the documents, displaying one or more of the documents, or printing one or more of the documents. The purchased product can be a pre-printed certificate. One or more of the fields can be a name field, a date field, or a certification field.

According to one or more aspects, a system for limiting reproduction of product designs is provided, including a design component configured to receive a purchased product selection, generate a product design based on the purchased product selection, wherein the purchased product selection corresponds to a purchased product, wherein the product design is associated with the purchased product, and insert or modify one or more design elements into the product design. The system can include a user interface (UI) component configured to display the product design or one or more product design portions and a print component configured to control a number of prints associated with the product design or one or more product design portions.

In one or more embodiments, the print component can be configured to monitor the number of prints associated with the product design or one or more of the product design portions. The system can include a communication component configured to receive payment information associated with the product design or one or more of the product design portions. The design component can be configured to receive a product number associated with the purchased product. The number of prints may be based on the product number. The print component may be configured to enable or disable printing of the product design or one or more product design portions to a file. The print component may be configured to install a print application on a device communicatively coupled to the system. The print application may enable or disable printing of the product design from the device based on a balance associated with an account. The system can include a registration component configured to associate an account with the product design or one or more of the product design portions or an access component configured to grant access or deny access to an account, the product design, or one or more of the product design portions based on a balance associated with the account.

According to one or more aspects, a method for limiting reproduction of product designs is provided. The method can include receiving a purchased product selection, generating a product design based on the purchased product selection, wherein the purchased product selection corresponds to a purchased product, wherein the product design is associated with the purchased product, inserting or modifying one or more design elements into the product design, displaying the product design or one or more product design portions, and controlling a number of prints associated with the product design or one or more product design portions.

The method can include monitoring the number of prints associated with the product design or one or more of the product design portions, receiving payment information associated with the product design or one or more of the product design portions, receiving a product number associated with the purchased product, enabling or disabling printing of the product design or one or more product design portions to a file. The number of prints may be based on the product number.

According to one or more aspects, a computer-readable storage medium including computer-executable instructions, which when executed via a processing unit on a computer performs acts, including receiving a purchased product selection, generating a product design based on the purchased product selection, wherein the purchased product selection corresponds to a purchased product, wherein the product design is associated with the purchased product, inserting or modifying one or more design elements into the product design, displaying the product design or one or more product design portions, and controlling a number of prints associated with the product design or one or more product design portions.

One or more of the acts can include monitoring the number of prints associated with the product design or one or more of the product design portions, receiving payment information associated with the product design or one or more of the product design portions, or receiving a product number associated with the purchased product.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A system for customization of a product design for merging data, comprising:
a design component configured to:
receive a purchased product selection;
generate a product design based on the purchased product selection, wherein the purchased product selection corresponds to a purchased product, wherein the product design is associated with the purchased product;
receive one or more user inputs, wherein one or more of the user inputs defines a location and a size for one or more fields, wherein a field is a design element;
customize the product design with one or more of the fields based on one or more of the user inputs; and
a merge component configured to:
receive a source data file comprising one or more source data entries;
generate one or more documents having the customized product design;
propagate one or more of the source data entries to one or more of the fields across one or more of the documents based on the customized product design; and
a user interface (UI) component configured to display one or more of the documents, wherein the respective documents have respective source data entries in the respective fields,
wherein the design component, the merge component, or the UI component is implemented via a processing unit.

2. The system of claim 1, wherein the purchased product selection corresponds to a certificate, a pre-printed certificate, a mailing label, letterhead, or an envelope.

3. The system of claim 1, wherein the source data file is a list, a text file, a spreadsheet, or a comma separated value (CSV) file.

4. The system of claim 1, wherein one or more of the fields is a name field, a date field, a certification details field, or data.

5. The system of claim 1, wherein the merge component is configured to propagate one or more of the source data entries based on a property of one or more of the source data entries.

6. The system of claim 5, wherein the property is a text font, size, or text attribute.

7. The system of claim 5, wherein the merge component is configured to propagate a date, day, or time to one or more of the fields based on a date field, a day field, or a time field.

8. The system of claim 1, comprising a print component configured to print one or more of the fields.

9. The system of claim 8, wherein the print component is configured to print one or more of the documents to a file.

10. The system of claim 1, comprising an access component configured to grant access or deny access to the merge component based on a product number associated with a pre-printed certificate product.

11. A method for customization of a product design for merging data, comprising:
receiving a purchased product selection;
generating a product design based on the purchased product selection, wherein the purchased product selection corresponds to a purchased product, wherein the product design is associated with the purchased product;
receiving one or more user inputs, wherein one or more of the user inputs defines a location and a size for one or more fields, wherein a field is a design element;
customizing the product design with one or more of the fields based on one or more of the user inputs;
receiving a source data file comprising one or more source data entries;
generating one or more documents having the customized product design;
propagating one or more of the source data entries to one or more of the fields across one or more of the documents based on the customized product design; and
displaying one or more of the documents, wherein the respective documents have respective source data entries in the respective fields,
wherein the receiving, generating, customizing, propagating, or displaying is implemented via a processing unit.

12. The method of claim 11, wherein the product design is implemented in extensible markup language (XML).

13. The method of claim 11, wherein the purchased product selection corresponds to a certificate, a pre-printed certificate, a mailing label, letterhead, or an envelope.

14. The method of claim 11, wherein the source data file is a list, a text file, a spreadsheet, or a comma separated value (CSV) file.

15. The method of claim 11, wherein one or more of the fields is a name field, a date field, a certification details field, or data.

16. The method of claim 11, wherein the merge component is configured to propagate one or more of the source data entries based on a property of one or more of the source data entries.

17. A computer-readable storage medium comprising computer-executable instructions, which when executed via a processing unit on a computer performs acts, comprising:
receiving a purchased product selection;
generating a product design based on the purchased product selection, wherein the purchased product selection corresponds to a purchased product, wherein the product design is associated with the purchased product;
receiving one or more user inputs, wherein one or more of the user inputs defines a location and a size for one or more fields, wherein a field is a design element;
customizing the product design with one or more of the fields based on one or more of the user inputs;
receiving a source data file comprising one or more source data entries;
generating one or more documents having the customized product design;
propagating one or more of the source data entries to one or more of the fields across one or more of the documents based on the customized product design; and
displaying one or more of the documents, wherein the respective documents have respective source data entries in the respective fields.

18. The computer-readable storage medium of claim 17, wherein the product design is implemented in extensible markup language (XML).

19. The computer-readable storage medium of claim 17, wherein the purchased product selection corresponds to a certificate, a pre-printed certificate, a mailing label, letterhead, or an envelope.

20. The computer-readable storage medium of claim 17, wherein the source data file is a list, a text file, a spreadsheet, or a comma separated value (CSV) file.
